(19) United States
(12) Patent Application Publication
(10) Pub. No.: US 2011/0208531 A1
(43) Pub. Date: Aug. 25, 2011

(54) Medical Office, Particularly for Surgical Eye Treatments

(75) Inventors: Armin Wellhoefer, Schwaig (DE); Christof Donitzky, Eckental/Eschenau (DE)

(73) Assignee: WAVELIGHT AG, Erlangen (DE)

(21) Appl. No.: 12/712,577

(22) Filed: Feb. 25, 2010

(51) Int. Cl. G06Q 50/00; G06Q 10/00; G06F 12/02; G06F 13/20; G06K 15/00

(52) U.S. Cl. 705/2; 711/103; 710/313; 358/1.16; 711/E12.008

(57) ABSTRACT

A medical office, particularly for surgical eye treatments, includes at least one medical device which is controlled by a program-controlled computer, with a first plug-in interface for a data storage medium, and a data printing device, which is decoupled electrically and for signalling purposes from the medical device, with a second plug-in interface for the data storage medium. According to the invention, the computer of the medical device is set up to write data into the data storage medium via the first plug-in interface, whereas the data printing device is set up to read and print data stored on the data storage medium. The data storage medium can, for example, be a USB memory stick or another transportable medium, for which, in the data processing industry, standardised plug-in locations are provided. Because no additional galvanic decoupling of the data printing device is necessary, as it would be in the case of direct electrical connection to the medical device, both the device complexity and the cost can be reduced.

The invention concerns the technical equipment of a medical office, in particular an office for surgical eye treatments. The term “office” must be understood broadly here, and as well as the offices of individual doctors includes the premises of larger aggregations of doctors, including clinics and hospitals.

In all such practices, a very wide variety of medical devices, with which diagnostic, therapeutic or/and surgical functions can be carried out, is always present. Complex diagnostic or treatment devices are nowadays usually implemented with a program-controlled computer, which controls the operation of the device as required by a suitable control program. In many of these program-controlled devices, extensive data, which for example represent the results of measurements (or in general investigations) which either result in images or work with other techniques, said measurements being carried out on a patient before, during or after an operation, are generated or/and managed. It is often desirable not only to display such data on a monitor, but also to make them available in printed form. For this purpose, the relevant computer-supported medical devices can be equipped with a printer, via which the data can be printed from the computer.

A problem is that products which are intended for use in a medical device must often conform to specified protection or/and quality regulations, which for example are legally stipulated, and checked by a licensing authority which is nationally or multinationally active. In such a case, only officially licensed products can be used in medical devices. In the case of electronic devices such as a computer or printer, this means, among other things, increased requirements for electrical safety, since it is necessary to ensure that in the case of a malfunction of the relevant electronic component, any danger to the patients because of electrical currents or voltages is excluded. Galvanic decoupling is one possibility for meeting the electrical requirements. In general, it is a fact that the required efforts, with respect to components, for licensing a product as a medical product result in the product becoming comparatively expensive. This also applies to medically permitted printers, which can be several times more expensive than traditional office printers without medical product licensing.

Against this background, according to the invention, a medical office, particularly for surgical eye treatments, is provided, said office including at least one medical device which is controlled by a program-controlled computer, with a first plug-in interface for a data storage medium, and a data printing device, which is decoupled electrically and for signalling purposes from the medical device, with a second plug-in interface for the data storage medium, the computer of the medical device being set up to write data into the data storage medium via the first plug-in interface, and the data printing device being set up to read and print data stored on the data storage medium.

The invention starts from the recognition that the control computer of computer-controlled medical devices is often already equipped with a suitable interface for connecting a portable data storage medium, and that for using such a data storage medium for transmitting specified print data from the computer to a printer, no special medical product licensing is necessary. Thus no direct electrical connection between the computer and the printer is required, so that expensive measures for galvanic decoupling (e.g. isolating transformer or optocoupler) can be avoided. The data can be stored in the computer and on the data storage medium in file formats which are arbitrary per se; the PRN, PDF, JPG and TIFF file formats can be mentioned purely as examples.

The medical device can, for example, be a diagnostic device or a laser, which is set up for therapeutic or/and surgical treatment of a human body part, e.g. of the eye.

The first and second plug-in interfaces (alternatively, the term “plug-in location” can be used for the plug-in interfaces) can each be, for example, a USB interface, a CF interface or an SD card interface. USB stands for Universal Serial Bus, while CF stands for Compact Flash and SD for Secure Digital. USB and CF describe different standards for interfaces for data transmission; similarly, SD cards are standardised memory cards which work on the principle of flash storage. It is understood that the plug-in locations of the computer and data printing device can conform to standards other than those mentioned. It is also understood that the plug-in locations can be in different forms depending on the applicable standard, e.g. in the form of a slot (for plugging in a data storage medium in the form of a card), or in the form of a socket (for plugging in a USB memory stick, for example).

Preferably, the data storage medium contains a flash memory, which is supplied via the interface with the necessary electrical operating energy for writing and reading out. In general, the data storage medium is preferably set up to draw all necessary electrical operating energy via the first and/or second plug-in interfaces.

Larger offices occasionally have patient stations which are separated spatially from each other, and at each of which at least one medical device is set up. For example, at least some of the patient stations can be set up for different diagnostics or/and different forms of treatment. Then, usefully, at several, in particular all, of the patient stations, the medical devices are each equipped with a first plug-in interface. This makes it possible to provide, for multiple medical devices, a common data printing device which is set up separately from these devices, thus avoiding the massive expenditure which would be necessary if each of the medical devices was equipped with a medically licensed printer.

The data printing device is usefully a product which does not require a medical licence. For example, it can include a computer and a printer, which is connected to the computer via a printer cable and can be driven via a suitable printer driver which is implemented in the computer. The second plug-in interface can be provided on the computer, so that to print out the medical data of a medical device, the data storage medium must be connected to the plug-in interface of the computer. From there, in a way which is known per se, the relevant file can be printed out on the printer by entering a print command.

In an alternative version, the data printing device does not require a separate computer. Instead, it can comprise a printer which is implemented with a second plug-in interface, has a direct print function, and makes it possible to print files (documents) directly from a USB memory stick or another data storage medium which is plugged into the second plug-in interface. Such printers with a direct print function are per se obtainable from the market.

From a procedural point of view, the invention also concerns a method of operating a medical office, particularly for surgical eye treatments, comprising:
providing at least one medical device controlled by a program-controlled computer, with a first plug-in interface,
plugging a data storage medium into the first plug-in interface,
writing data from the computer into the data storage medium,
removing the data storage medium from the first plug-in interface,
providing a data printing device, which is decoupled electrically and for signalling purposes from the medical device, with a second plug-in interface,
plugging the data storage medium into the second plug-in interface,
reading data stored on the data storage medium by the data printing device,
printing the read-out data by the data printing device.

The invention makes it possible to operate a traditional office printer (without medical product licensing) in connection with a computer-supported device which is medical and therefore requires corresponding licensing, without requiring active galvanic separation, which would necessitate an additional device and thus additional costs, for the printer. By avoiding any electrical and signalling connection between the medical device and the printer (or in general the data printing device), and also not providing a wireless signalling connection, for example within a Bluetooth network or WLAN, maximum patient safety is ensured. Since no medical licensing is required for the data printing device, and nor is expensive validation of other hardware, immediate implementation of the invention in the everyday routine of operating a medical office is possible.

1. Medical office, particularly for surgical eye treatments, including at least one medical device which is controlled by a program-controlled computer, with a first plug-in interface for a data storage medium, and a data printing device, which is decoupled electrically and for signalling purposes from the medical device, with a second plug-in interface for the data storage medium, the computer of the medical device being set up to write data into the data storage medium via the first plug-in interface, and the data printing device being set up to read and print data stored on the data storage medium.

2. Medical office according to claim 1, wherein the first and second plug-in inter-faces are each a USB interface, a CF interface or an SD card interface.

3. Medical office according to claim 2, wherein the data storage medium is in the form of a card or stick.

4. Medical office according to claim 1, wherein the data storage medium contains a flash memory.

5. Medical office according to claim 2, wherein the data storage medium is set up to draw all necessary electrical operating energy via the first and/or second plug-in interfaces.

6. Medical office according to claim 1, with multiple patient stations which are separated spatially from each other, and at each of which at least one medical device is set up, with a first plug-in interface.

7. Medical office according to claim 1, wherein the second plug-in interface is provided on a printer with a direct printing function.

8. Medical office according to claim 1, wherein the data printing device is a product which does not require a medical licence.

9. Method of operating a medical office, particularly for surgical eye treatments, comprising:
providing at least one medical device controlled by a program-controlled computer, with a first plug-in interface;
plugging a data storage medium into the first plug-in interface;
writing data from the computer into the data storage medium;
removing the data storage medium from the first plug-in interface;
providing a data printing device, which is decoupled electrically and for signalling purposes from the medical device, with a second plug-in interface;
plugging the data storage medium into the second plug-in interface;
reading data stored on the data storage medium by the data printing device; and
printing the read-out data by the data printing device.
